(19) United States
(12) Patent Application Publication
(10) Pub. No.: US 2010/0269670 A1
(43) Pub. Date: Oct. 28, 2010

(54) Foot-Operated Audio Effects Device

(76) Inventors: Sam Fion Taylor O'Connor, Victoria (AU); Jefferson Grey Harcourt, Victoria (AU)

Correspondence Address: FISH & RICHARDSON PC, P.O. BOX 1022, MINNEAPOLIS, MN, 55440-1022, US

(21) Appl. No.: 12/670,203

(22) PCT Filed: Jul. 25, 2008
(86) PCT No.: PCT/AU08/01083

§ 371 Date: Jun. 28, 2010

(30) Foreign Application Priority Data
Jul. 26, 2007 (AU) 2007904025
Mar. 11, 2008 (AU) 2008901175

(51) Int. Cl. G10H 1/02

(52) U.S. Cl. 84/626; 84/746

(57) ABSTRACT

A foot-operated audio effects device (10) receives, stores and operates at least one software audio effect plug-in (86). At least two of the audio effect plug-in (86) may be designed to operate under different operating systems. The device (10) may receive multiple audio input streams (38, 40). Users can control at least one parameter of the audio effect plug-ins (86). The device (10) may include a mass storage device (72) which stores audio which has been generated within the device (10). In use, the device (10) may be connected to a computer (110) and software audio effect plug-ins (86) transferred to and stored in the device (10). The computer (110) may be used to configure parameters of the audio effect plug-in (86). Those parameters may be stored within the computer (110).

### RELATED APPLICATION

This application is based on and claims the benefit of the filing dates of AU applications nos. 2007904025 filed 26 Jul. 2007 and 2008901175 filed 11 Mar. 2008, the contents of which as filed are incorporated herein by reference in their entirety.

### FIELD OF THE INVENTION

The present invention relates to foot-operated audio effects devices suitable for stage performances or sound recording.

### BACKGROUND OF THE INVENTION

In the fields of stage performances and sound recording, audio effects are applied to the audio from musical instruments, such as an electric guitar, or vocals from a microphone. These audio effects alter the audio in a way that enhances the performance by adding audio effects such as distortion, delay or many other audio effects to the input audio stream which then enhances the final output sound. In a typical application the audio stream is input into a foot-operated audio effect device which alters the input audio stream and then the audio stream from the foot-operated audio effect device is output as an output audio stream through to an output receiving device such as an amplifier, DI box (direct input), wireless transmitter, headphones or mixing desk.

Traditionally, audio effects have been applied by using foot-operated analogue single audio effect devices sometimes called “foot pedals”, “stomp boxes” or “guitar pedals”. Such foot-operated audio effect devices were analogue devices and produced only one audio effect to be applied to the audio stream. The foot-operated audio effect devices are usually operated by a foot pedal to switch the audio effect on and off, or to actuate a controllably, continuously variable audio effect such as the “wha-wha” audio effect.

One limitation of such foot-operated audio effect devices is that they provide only one audio effect, which limits the performer's creativity. Sometimes a series of these foot-operated audio effect devices are used to provide a number of selectable audio effects. Such a series arrangement necessitates using an array of different foot-operated audio effect devices resulting in a complex, expensive, time-consuming and unreliable system to generate the audio effects. If any one of the foot-operated audio effects devices fails in such a complex setup, then it will produce either no sound or inferior sound.

There are also foot-operated multi audio effects device sometimes called a “multi-effects foot pedal” or a “digital multi-effects pedal”. These combine a number of audio effects into one foot-operated audio effect device. They typically use digital signal processing (DSP) technology to emulate a fixed number of foot-operated analogue single audio effect devices and provide foot pedals for selecting the currently active audio effect or, to actuate a controllably continuously variable audio effect.

Foot-operated multi audio effects devices are limited to a fixed number of selectable audio effects and so are not flexible or extensible. The performer is limited to the audio effects provided with the foot-operated multi audio effects device they have purchased. The DSP hardware is also often inferior in the sound quality it produces compared with the foot-operated analogue single audio effect device it emulates.

There are also standard software plug-in audio effects (plug-ins) which operate through a host program on a powerful laptop computer or PC. An industry standard plug-in is the virtual studio technology (VST) plug-in. In a typical application audio stream is input to the soundcard of a computer. The performer operates the host program which applies the selected plug-in to the input audio stream. The performer may also manipulate the adjustable parameters of the plug-in. The altered audio stream is then output to an output receiving device. The host program may also be controlled by an external musical instrument data interface (MIDI) controller which is operated to select the active standard software plug-in audio effect and manipulate its adjustable parameters.

A disadvantage with the plug-ins operating through a computer is that the computer is not suited to the hostile environment of live performances which can include drink spillage, moshing, or handling by roadies. Such performances involve the continual set-up and tear-down of sound equipment and travel between venues for the live performances. The sound equipment must, therefore, be rugged, but a computer is a fragile piece of equipment that is liable to be damaged by such activities and environments. Also it is not acceptable that the computer freeze-up and need rebooting during a live performance, or that a background process running on the computer cause an audio glitch as this would impair the quality of the performance.

### SUMMARY OF THE INVENTION

According to a first aspect of the present invention, there is provided a foot-operated audio effects device, adapted to receive, store and operate at least one software audio effect plug-in.

The at least one software audio effect plug-in may be a standard software audio effect plug-in. The at least one software audio effect plug-in may be user-selected.

The at least one software audio effect plug-in may comprise a VST plug-in. The device may comprise an X86 based effect pedal adapted to receive, store and operate at least one VST audio effect plug-in.

It is preferred that the foot-operated audio effects device is adapted to receive and simultaneously store a plurality of user-selected standard software audio effect plug-ins. In this case, it is preferred that the foot-operated audio effects device is adapted to simultaneously operate at least two of the user-selected standard software audio effect plug-ins.

It is preferred that at least two of the plurality of user-selected standard software audio effect plug-ins are designed to operate under different operating systems.

It is preferred that the foot-operated audio effects device is adapted to receive a plurality of input audio streams.

It is preferred that the foot-operated audio effects device is adapted to process at least one of the input audio streams with at least two of the user-selected standard software audio effect plug-ins.

It is preferred that the foot-operated audio effects device is adapted to simultaneously process at least two of the plurality of input audio streams with one of the user-selected standard software audio effect plug-ins.

It is preferred that the foot-operated audio effects device is adapted to produce at least two output audio streams.

It is preferred that the foot-operated audio effects device further comprises at least one user-adjustable control that is adapted to allow the user to control at least one parameter of the software audio effect plug-in.

It is preferred that the foot-operated audio effects device further comprise a mass storage device that is adapted to store audio which has been generated by application of at least one of the user-selected standard software audio effect plug-in that is stored within the device.

According to a second aspect of the present invention, there is provided a method of using a foot-operable audio effects device, the method comprising:

connecting an external device to the foot-operable audio effects device;

transferring at least one user-selected audio effect plug-in from the external device to the foot-operable audio effects device; and

storing said at least one user-selected audio effect plug-in (such as a VST plug-in) in the foot-operable audio effects device.

The external device may be a computing device (such as a PC or the like), used to configure at least one parameter of the standard software plug-in.

The method may comprise saving, within the external device, at least one of the parameters of the user-selected audio effect plug-in that has been configured.

The method may comprise providing an application on said external device for generating an emulation of said audio effects device, said emulation being user controllable and adapted to generate configuration data that is loadable into said audio effects device and usable by said audio effects device as configuration data.

The configuration data may comprise plug-in parameter settings.

The configuration data may comprise settings for a group of plug-ins configured to operate together.

According to a third aspect of the present invention, there is provided an audio generating or playback device, adapted to receive, store and operate at least one software audio effect plug-in (such as a VST plug-in), and to output said audio with the at least one software audio effect plug-in applied thereto.

Thus, a device is provided that can generate or playback audio material (from, for example, a digital recording) with one or more audio effects applied according to the at least one (but commonly more than one) software audio effect plug-in (and not merely process an audio signal). The device of this aspect may have any of the preferred features of the first aspect.

According to a fourth aspect of the present invention, there is provided a method of using an audio generating or playback device, the method comprising:

connecting an external device to the device;

transferring at least one user-selected audio effect plug-in (such as a VST plug-in) from the external device to the device; and

storing said at least one user-selected audio effect in the device.

According to a fifth aspect of the present invention, there is provided a computing device provided with or running a computer program for generating an emulation of a foot-operable audio effects device, the emulation being user controllable and adapted to generate configuration data that is loadable into the audio effects device and usable by the audio effects device as configuration data.

According to a sixth aspect of the present invention, there is provided a computer storage medium provided with a computer program adapted to generate an emulation of a foot-operable audio effects device, the emulation being user controllable and adapted to generate configuration data that is loadable into the audio effects device and usable by the audio effects device as configuration data.

### BRIEF DESCRIPTION OF THE DRAWINGS

In order that the invention may be more fully ascertained, preferred embodiments will now be described, by way of example, with reference to the drawings, in which:

FIG. 1 is a schematic top view of a foot-operated audio effects device according to a preferred embodiment of the present invention;

FIG. 2 is a schematic rear view of the foot-operated audio effects device of the embodiment of FIG. 1;

FIG. 3 is a schematic side view of a foot-operated audio effects device of the embodiment of FIG. 1;

FIG. 4 is a schematic diagram of the hardware architecture of the foot-operated audio effects device of the embodiment of FIG. 1;

FIG. 5 is a schematic view of data-flows within the embedded software that is executed on the microprocessor of the foot-operated audio effects device of the embodiment of FIG. 1;

FIG. 6 illustrates the layered software architecture of the embedded software described by reference to FIG. 5;

FIG. 7 is a schematic view of the foot-operated audio effects device of the embodiment of FIG. 1 connected to a laptop computer, illustrating the downloading of VST effects plugins according to a preferred embodiment of the present invention;

FIG. 8 illustrates the connection of a guitar to the foot-operated audio effects device of the embodiment of FIG. 1; and

FIG. 9 illustrates the use of the foot-operated audio effects device of the embodiment of FIG. 1 in a stand-alone, performance mode.

### DETAILED DESCRIPTION OF THE PREFERRED EMBODIMENTS

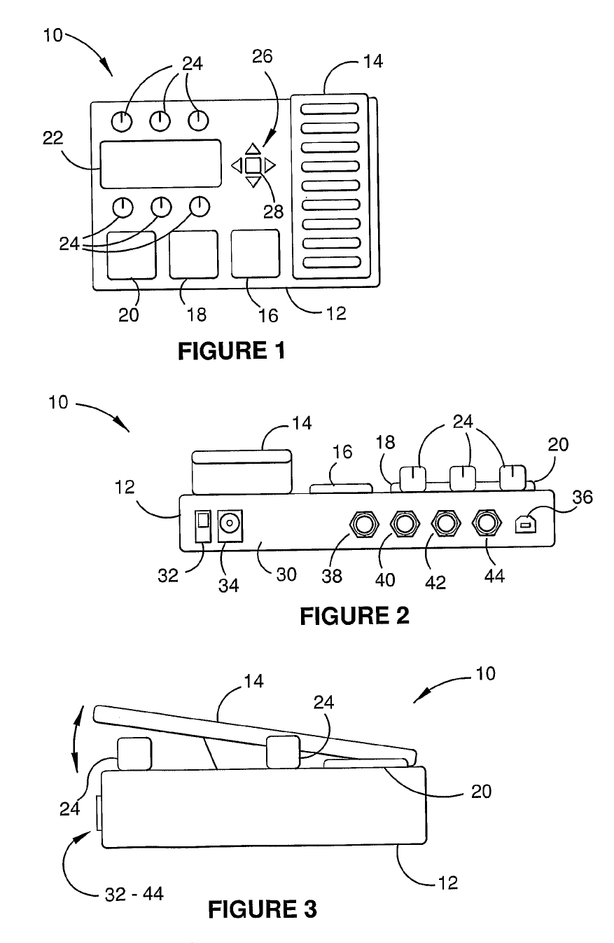

FIGS. 1, 2 and 3 are schematic top, rear and side views of a foot-operated audio effects device 10 according to a preferred embodiment of the present invention. Device 10 has a case in the form of a rugged, splash resistant enclosure 12, and is designed to be placed on the floor and manipulated by foot. A continuously variable foot pedal 14 allows live control of effect parameters, for example, “wha-wha” or distortion level. Device 10 includes a ‘next’ foot-switch 16 and a ‘previous’ foot-switch 18 that allow the performer to quickly select between previously stored presets, and a third, configurable foot-switch 20 that may be configured to perform an arbitrary function appropriate to the currently selected effects plugin. For example, configurable foot-switch 20 may be configured to trigger the start and end of recording for a loop recording/playback effect. Device 10 also includes an LCD display 22 for displaying the currently selected preset and plugin names.

Device 10 is adapted to receive, store and operate (that is, apply to inputted signals) a plurality of user-selected VST effect plug-ins, and to simultaneously operate at least two of the VST effect plugins.

Device 10 has, positioned adjacent to display 22, six continuously rotary control knobs 24 for adjusting additional effect parameters. For example, for a reverb effect knobs 24 could adjust: room size, brightness, decay time, frequency response and the like. Knobs 24 are positioned adjacent to display 22, and the name of the parameter currently assigned to each knob 24, along with the current value of that parameter, is displayed by display 22 adjacent to the respective knob 24.

Device 10 also has a set of arrow buttons 26 and a selection button 28 to allow configuration of device 10 when it is not connected to a laptop. Arrow buttons 26 and selection button 28 can be used to navigate menus displayed on display 22 for the purpose of creating and modifying presets, switching between banks of parameter-knob assignments, and the like.

As is illustrated in FIG. 2, the back panel 30 of device 10 has an on-off switch 32, a DC power socket 34 and a standard USB slave socket 36. Also provided on back panel 30 are guitar input 38 and microphone input 40, and guitar and microphone outputs 42,44 for the processed signals from each of guitar and microphone inputs 38,40. Guitar input 38 is configurable for either piezo or magnetic pickups via the input configuration menu accessed with display 22, arrow buttons 26 and selection button 28. Microphone input 40 is configurable for either microphone or line level input via the input configuration menu. When the input configuration menu is being displayed on display 22, rotary knobs 24 can be used to set the input and output gain levels for each of guitar and microphone inputs and outputs 38,40,42,44.

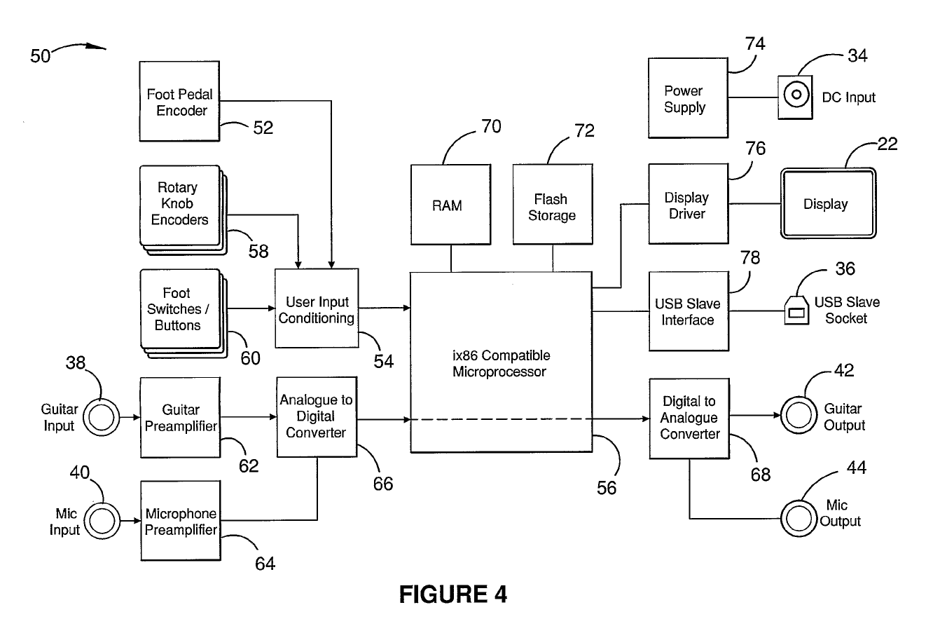

FIG. 4 is a schematic diagram of the hardware architecture 50 of device 10. The electronic components of device 10 are mounted on a single special-purpose PCB (not shown) housed within enclosure 12. Foot pedal 14 is connected to a continuous rotary encoder 52 which is connected to a user input conditioning module 54 whereby the position of the foot pedal is monitored by software running on a micro-processor 56. Likewise, rotary knobs 24 are connected to encoders 58 whereby their position is monitored by micro-processor 56 via user input conditioning module 54. Foot switches 60 are monitored via user input conditioning module 54 in a similar way. Guitar input 38 and microphone input 40 are connected to a guitar preamplifier 62 and a microphone preamplifier 64, respectively, whereby the input signals are amplified to a level suitable for processing by an analogue to digital converter 66. Analogue to digital converter 66 supplies the digitised input signals to microprocessor 56, where they are processed by installed VST effect plugins. The processed signals are then sent to a digital to analogue converter 68, the resulting analogue signals from which are sent to guitar output 42 and microphone output 44, respectively.

Hardware 50 also includes RAM 70 directly soldered to the PCB, a solid state flash storage chip 72 (though other forms of memory, such as a hard disk, may also be suitable) for storing embedded software and downloaded VST effect plugins, a power supply module 74 for conditioning DC power provided via DC input socket 34, a display driver 76 for driving display 22, and a USB slave interface 78 to facilitate the connection of device 20 to a general purpose PC or laptop computer via USB socket 36.

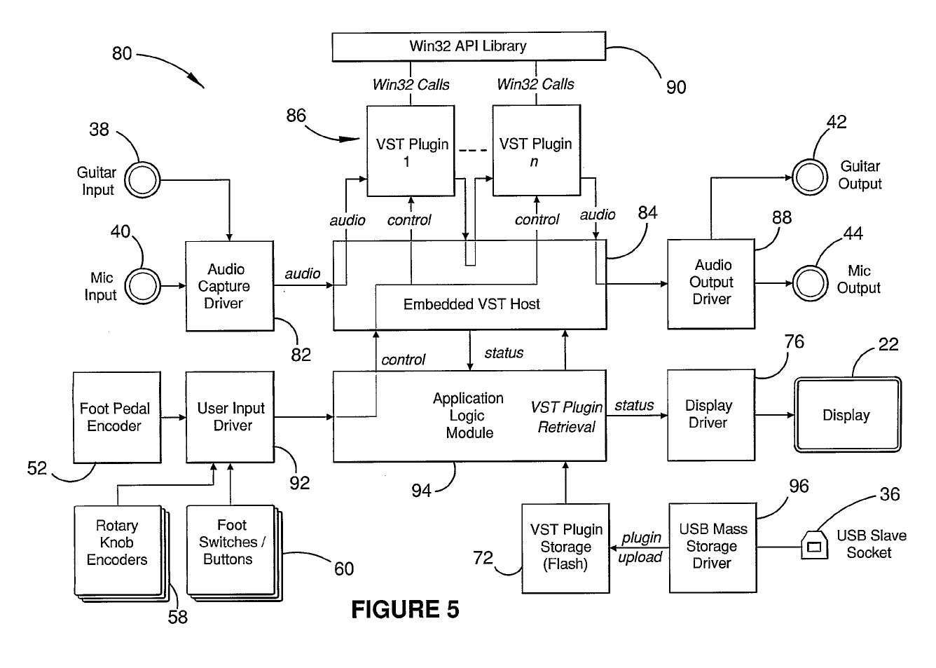

FIG. 5 is a schematic view of data-flows 80 within the embedded software that is executed on microprocessor 56. Input from guitar input 38 and microphone input 40 is captured by the interrupt driven, kernel level, audio capture driver 82. An embedded VST host 84 passes the audio input stream from the audio capture driver 82 to each of one or more currently active VST plugins 86 in turn. The processed audio signal is then sent to the kernel level audio output driver 88 which sends it to guitar output 42 or microphone output 44. VST plugins 86, which are adapted to run—in this embodiment—on an ix86 Windows PC, execute natively on the ix86 microprocessor 56. However, plugins 86 also make Win32 API calls, which would normally be handled by the Windows (trade mark) operating system. Accordingly, device 10 includes a Win32 API Library 90 running under an embedded operating system to handle these calls.

Inputs from the foot pedal encoder 52, rotary knob encoders 58 and foot switches/buttons 60 are captured by interrupt driven, kernel level, user input driver 92. An application logic module 94 responds to events from user input driver 92 and sends control commands to VST host 84 to:

adjust parameters of currently loaded plugins 86;

change interconnections between the currently loaded plugins 86; and

load new plugins 86 from the VST plugin storage area (i.e. flash storage chip 72) into VST host 84.

Application logic module 94 also updates display 22 via kernel level display driver 76 to display the current preset, currently loaded plugins, current parameter values, menus etc.

A USB mass storage driver 96 makes VST plugin storage area 72 visible on a laptop or PC that is connected via USB slave socket 36. This allows new plugins to be loaded into VST plugin storage area 72 from the laptop or PC.

Not illustrated for the sake of simplicity is the connection from the audio output driver to the USB slave socket 36. This connection makes the audio output signal available as a class compliant USB audio input on a PC or laptop connected via USB slave socket 36. Data outputted by user input driver 92 is also passed to USB slave socket 36 as a MIDI data stream that is visible on the PC or laptop as a class compliant USB MIDI input and can be used to control arbitrary MIDI aware software on the PC/laptop.

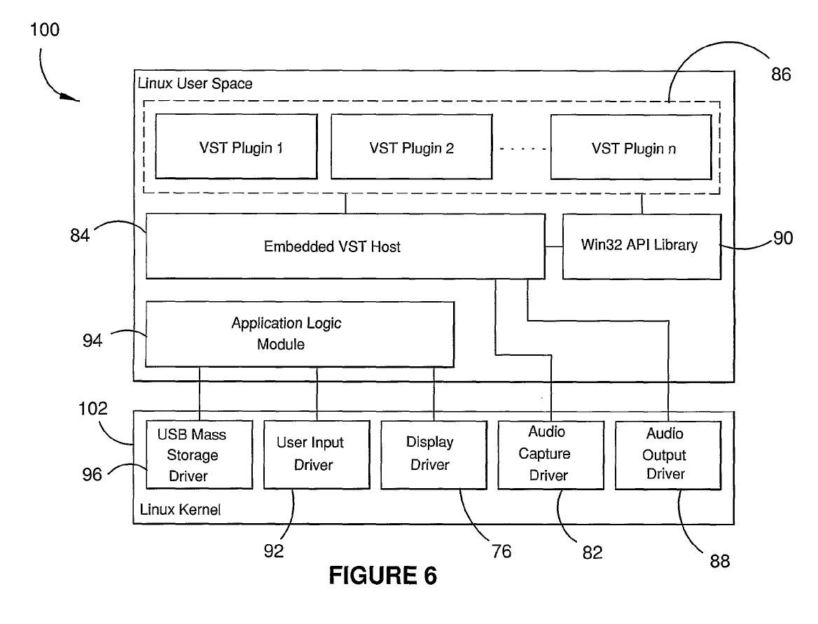

FIG. 6 illustrates the layered software architecture 100 of embedded software described above by reference to FIG. 5. The software is based on an embedded operating system kernel 102 incorporating USB mass storage driver 96, user input driver 92, display driver 76, audio capture driver 82 and audio output driver 88. On top of operating system kernel 102 the remaining modules are implemented as user space applications and libraries. The application logic module 94 controls embedded VST host 84, which controls VST plugins 86. Application logic module 94 manages interactions with USB mass storage driver 96, user input driver 92 and display driver 76. Embedded VST host 84 deals with audio input and output with audio capture driver 82 and audio output driver 88, as well as passing audio and control to VST plugins 86. VST plugins 86 run on top of Win32 AIP Library 90 which handles the Win32 API calls that would normally be handled by the Windows (trade mark) operating system on a general purpose PC.

Microprocessor 56 does not have the full range of peripheral devices that would be connected in a typical general purpose PC. RAM 70 is directly soldered to the PCB instead of SIM sockets. Flash storage chip 72 is used in this embodiment instead of a hard disk for storage of embedded software and downloaded VST effect plugins. Although display driver 76, USB slave interface 78, analogue to digital converter 66 and digital to analogue converter 68 are depicted as discreet modules in the figures, they are in fact incorporated into a package with microprocessor 56 to reduce chip-count and manufacturing cost.

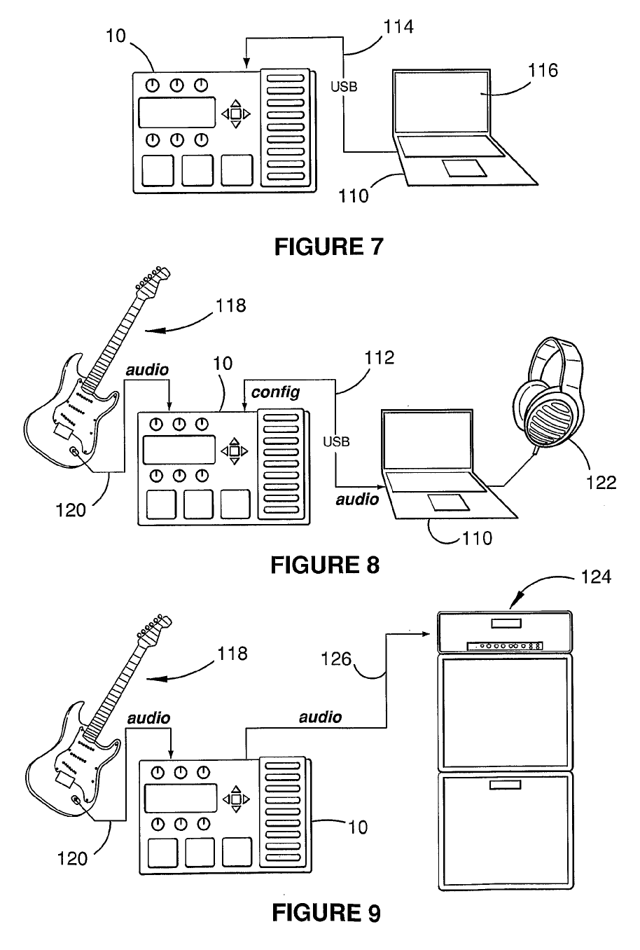

FIG. 7 is a schematic view of device 10 connected to a standard PC or Mac (trade mark) laptop 110 (or other computer, such as a desk-top PC) with a standard USB cable 112, to illustrate the, downloading of VST effects plugins according to a preferred embodiment of the present invention from laptop 110 via USB cable 114 to device 10. Upon the connection of device 10 and laptop 110 with USB cable 112, a representation of device 10 is displayed by laptop 110 on its display 116. That representation shows device 10 as a removable storage device.

FIG. 8 illustrates the connection of a guitar 118 to device 10 via a standard guitar lead 120, whereby the signal from the electrical pickup of guitar 118 is transmitted to and processed by device 10. Device 10 modifies the signal according to the VST effects plugins 86 currently downloaded to it and the settings of its controls as set with control knobs 24, etc. The modified signal is digitally transmitted to laptop 110 via USB cable 112. When USB cable 112 is connected, in addition to device 10 appearing as a removable storage device as described above by reference to FIG. 7, device 10 appears as a USB class compliant audio input device. The audio signal received by laptop 110 can be monitored on a headset 122 or used in any desired fashion on laptop 110. Additionally, software running on laptop 110 can be used to fine-tune the configuration of the VST effects plugins 86 installed on device 10. This software also supports the creation of presets, which capture certain configurations of certain combinations of effects, and which can be quickly recalled later when device 10 is disconnected from laptop 110.

FIG. 9 illustrates the use of device 10 in a stand-alone, performance mode in a stage environment. Guitar 118 is connected via guitar lead 120 to device 10, and an amplifier and speakers 124 are connected via a standard line-level audio output lead 126. Knobs 26 and the other controls of device 10 allow the selection of plugins 86, the recalling of previously configured presets and live modification of plugin parameters. In an alternative embodiment, audio output lead 126 is connected to a mixing desk, a DI-box or a wireless transmitter as part of a more complex sound system.

In some embodiments, device 10 is configured to interface with laptop 110 to exchange configuration data. Such configuration data includes, for example, plug-in parameter settings and bank settings (that is, for groups of plug-ins configured to operate together). The exchange of configuration data with laptop 110 can be effected via USB cable 112 or a USB memory device (such as a USB ‘stick’). This exchange is facilitated by providing laptop 110 with an application (typically a software application written for the relevant operating system, such as Windows (trade mark) or Mac (trade mark)) that emulates device 10. This application controls laptop 110 to create a software emulation of device 10 and to display a representation of device 10 on display 116 of laptop 110; the representation of device 10 has user-manipulable controls so that the user, by manipulating the keyboard and/or mouse of laptop 110, can configure a complex plug-in, which may have several hundred parameters, and—once configured, transfer the resulting plug-in to device 10. It should be noted that the emulation of device 10 is able to operate the audio hardware of laptop 110, thereby allowing the user to test the plug-in before transferring it to device 10 by firstly playing sound with the application.

A group of such plug-ins can be connected to form a plug-in bank. For example, a guitar effect bank may comprise a distortion module feeding into a delay module, which then feeds in to a “wha-wha” pedal effect. The application can be controlled by the user to create plug-ins banks on laptop 110.

Once the user has constructed one or more plug-ins or plug-in banks, and configured the desired plug-ins, the application can be controlled to construct a configuration file, which can then be transferred—as discussed above—to device 10. Device 10 then loads this configuration file (which may also contain plug-in executable code for the plug-ins that the user desires to use), and operates in the same manner as did the emulation of device 10 emulated by the application on laptop 110. This allows the user to, for example, create a setup in a studio using the application, transfer it to device 10, and use it on stage with device 10. If changes are made to a configuration file of configuration data (including plug-in parameter settings and bank settings) on device 10 while on stage, by the user controlling device 10 with typically arrow buttons 26 and selection button 28, the updated configuration file can be transferred to laptop 110 (via USB cable 112 or a USB memory device) for use back in the studio or on another device comparable to device 10.

Modifications within the scope of the invention may be readily effected by those skilled in the art. It is to be understood, therefore, that this invention is not limited to the particular embodiments described by way of example hereinabove.

Furthermore, in the claims that follow and in the preceding description of the invention, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference herein to prior art is not intended to imply that such prior art forms or formed a part of the common general knowledge in Australia or any other country.

1. A foot-operable audio effects device, adapted to receive, store and operate at least one software audio effect plug-in.

2. A device as claimed in claim 1, adapted to receive and simultaneously store a plurality of software audio effect plug-ins.

3. A device as claimed in claim 2, adapted to simultaneously operate at least two of the software audio effect plug-ins.

4. A device as claimed in claim 2, wherein at least two of the plurality of software audio effect plug-ins are designed to operate under different operating systems.

5. A device as claimed in claim 1, adapted to receive a plurality of input audio streams.

6. A device as claimed in of claims 2, adapted to receive a plurality of input audio streams and to process at least one of the input audio streams with at least two of the software audio effect plug-ins.

7. A device as claimed in claim 5, adapted to simultaneously process at least two of the plurality of input audio streams with one of the software audio effect plug-ins.

8. A device as claimed in claim 1, adapted to produce at least two output audio streams.

9. A device as claimed in claim 1, further comprising at least one user-adjustable control that is adapted to allow the user to control at least one parameter of the at least one software audio effect plug-in.

10. A device as claimed in claim 1, further comprising a mass storage device that is adapted to store audio which has been generated by application of the at least one software audio effect plug-in that is stored within the device.

11. A device as claimed in claim 1, wherein said at least one software audio effect plug-in comprises a VST plug-in.

12. A device as claimed in claim 1, wherein said device comprises an X86 based effect pedal adapted to receive, store and operate at least one VST audio effect plug-in.

13. A method of using a foot-operable audio effects device, the method comprising:
connecting an external device to the foot-operable audio effects device; and
transferring at least one user-selected audio effect plug-in from the external device to the foot-operable audio effects device; and
storing said at least one user-selected audio effect plug-in in the foot-operable audio effects device.

14. A method as claimed in claim 13, wherein:
the external device is a computing device; and
the computing device is used to configure at least one parameter of the standard software plug-in.

15. A method as claimed in claim 13, further comprising saving, within the external device, at least one of the parameters of the user-selected audio effect plug-in that has been configured.

16. A method as claimed in claim 13, including providing an application on said external device for generating an emulation of said audio effects device, said emulation being user controllable and adapted to generate configuration data that is loadable into said audio effects device and usable by said audio effects device as configuration data.

17. A method as claimed in claim 16, wherein said configuration data comprises plug-in parameter settings.

18. A method as claimed in claim 16, wherein said configuration data comprises settings for a group of plug-ins configured to operate together.

19. An audio generating or playback device, adapted to receive, store and operate at least one software audio effect plug-in, and to output said audio with the at least one software audio effect plug-in applied thereto.

20. A method of using an audio generating or playback device, the method comprising:
connecting an external device to the device;
transferring at least one user-selected audio effect plug-in from the external device to the device; and
storing said at least one user-selected audio effect in the device.

21. A computing device provided with or running a computer program for generating an emulation of a foot-operable audio effects device, said emulation being user controllable and adapted to generate configuration data that is loadable into said audio effects device and usable by said audio effects device as configuration data.

22. A computer storage medium provided with a computer program adapted to generate an emulation of a foot-operable audio effects device, said emulation being user controllable and adapted to generate configuration data that is loadable into said audio effects device and usable by said audio effects device as configuration data.

23. A computing device provided with or running a computer program encoding a method as claimed in claim 13.

24. A computer storage medium provided with a computer program embodying a method for as claimed in claim 13.

25-26. (canceled)

27. A computing device provided with or running a computer program encoding a method as claimed in claim 20.

28. A computer storage medium provided with a computer program embodying a method for as claimed in claim 20.
